(19) United States
(12) Patent Application Publication
(10) Pub. No.: US 2015/0189052 A1
(43) Pub. Date: Jul. 2, 2015

(54) Head Mounted Cell Phone Holder

(71) Applicant: Karen Sconiers, North Las Vegas, NV (US)

(72) Inventor: Karen Sconiers, North Las Vegas, NV (US)

(21) Appl. No.: 14/146,647

(22) Filed: Jan. 2, 2014

(51) Int. Cl. H04M 1/05; H04B 1/38

(52) U.S. Cl. CPC H04M 1/05; H04B 1/385; H04B 2001/3866

(57) ABSTRACT

An apparatus enabling hands free operation of cell phones and other portable electronic devices comprising a flexible inverted U-shaped headband with a holding member attached to one end of the headband wherein the bottom of the holding member has one or more arms attached. The apparatus rests on a user's head with a cell phone placed between one of the user's ears and the holding member on the headband where the holding member supports the rear of the cell phone and the arms of the apparatus are positioned to support the cell phone from underneath. The headband has means to adjust the apparatus to comfortably accommodate different shaped heads and ear locations. The arms can be independently adjusted telescopically and horizontally to support a variety of different sized portable electronic devices from underneath.

### BACKGROUND OF THE INVENTION

1. Field of the Invention

The present invention relates in general to hands-free holders of cell phones and other portable electronic devices and more particularly to hands-free holders that use a headband to position a cell phone or portable electronic device over the user's ear.

2. Description of the Prior Art

With the rapid proliferation of cell phone use in recent years there has been an increasing need for accessories to allow cell phone users to operate their phones while keeping their hands available for other tasks. Hands-free operation of telephone handsets began as far back as 1934 with U.S. Pat. No. 1,951,332 to Barclay. As telephone technology evolved, so did the devices created for hands-free use of handsets. Hands-free holders were invented for cordless telephone handsets such as the one disclosed in U.S. Pat. No. 5,706,345 to Allen when such phones became widespread.

Hands-free holders have also been invented to suit modern cell phones. Many such devices incorporate headbands such as taught in U.S. Pat. No. 6,038,312 to Bromley; U.S. Pat. No. 7,120,247 to Wade; U.S. Pat. No. 7,155,265 to Medhin; and U.S. Pat. No. 7,508,932 B1 to Bergh.

U.S. Pat. No. 6,038,312 to Bromley teaches a hands-free handset holder using a headband with a clamping mechanism at one end to hold a handset to the apparatus. The clamping force holding the handset to the headband is produced from a screw which when screwed down pushes on a pad that squeezes the handset in between it and the other fixed side.

U.S. Pat. No. 7,120,247 to Wade teaches a couple of different methods of attaching a cell phone to one end of a headband. Wade describes using magnets, a clip, or hook and loop fasteners to hold a cell phone to the headband. The means used for holding the cell phone require attaching to the phone body part of the means for attachment.

Medhin's patent U.S. Pat. No. 7,155,265 discloses an over the head hands-free apparatus with two arms that exert force to opposite sides of a cell phone, clamping the phone in place. The two parallel straight arms are adjustable to permit cell phones of various widths to be clamped in between the arms.

Finally, Bergh's patent U.S. Pat. No. 7,508,932 B1 teaches a cell phone holder headband that utilizes an elastic band to secure a phone to the headband. A plate holding the elastic strap pivots in relation to the headband allowing the phone to be angled in a way that positions the microphone near the user's mouth. The headband coils up when the user is not using the phone hands-free with the intent of allowing the phone to be operated without removing it from the coiled apparatus.

### SUMMARY OF THE INVENTION

It is an object of the present invention to provide a holder for a variety of different shaped cell phones allowing hands-free operation of a cell phone. It is a further object of the invention to allow hands-free operation of a cell phone by holding the cell phone to the side of the user's head in a position where the cell phone speaker is over one of the user's ears and the microphone is in a position to clearly capture the user's voice. Another object of the present invention is for the apparatus to be adjustable to accommodate different shaped phones or other portable electronic devices as well as different user's heads. Another object of the present invention is to hold a cell phone in a way that the cell phone can be placed in the holder, and removed, quickly.

Other objects and advantages of the invention will become apparent from the following detailed description of its specific embodiment, with reference to the accompanying drawings.

To these ends, the present invention generally comprises a headband having the general form of an inverted U-shape. The headband is made from a flexible material with a means to adjust the headband length to accommodate different sized user's heads. One end of the headband is terminated with by a support pad that rests on the user's head above one of the user's ears. The other end of the headband is terminated by a holding member. The holding member comprises a large pad that rests against the rear of a cell phone or other portable electronic device with one or more arms attached to the large pad. The cell phone is held in place due to the headband pushing the large pad against the rear of the phone which in turn pushes the phone against the user's ear while one or more arms are positioned underneath the phone to prevent the phone from slipping down due to gravity.

In the preferred embodiment, the headband is made from a flexible plastic material with a means of adjusting the length of the headband in the middle of the headband. The support pad is molded into the plastic headband and is generally in the form of a rectangle, with the inner face covered by a layer of foam cushioning. The holding member's large pad is generally in the form of a rectangle with the inner face covered in a layer of foam cushioning and is attached to one end of the headband with a means to adjust the holding member's position vertically. The large pad has two adjustable length J-shaped arms attached to the lower edge of the large pad. The end of the arm opposite of the curled end attaches to the large pad with the arms extending vertically downward and with the curled end directed inside towards the user's head. The arms are covered in foam cushioning on the inner facing surfaces. The arms can also be adjusted independently along the length of the large pad.

### BRIEF DESCRIPTION OF THE DRAWINGS

FIG. 1 depicts a top left perspective view of the head mounted cell phone holder in accordance with an embodiment of the present invention.

FIG. 2 depicts a detail view of the adjustment means for the headband of the head mounted cell phone holder in accordance with an embodiment of the present invention.

FIG. 3 depicts a detail view of the holding member of the head mounted cell phone holder in accordance with an embodiment of the present invention.

### DESCRIPTION OF THE PREFERRED EMBODIMENT

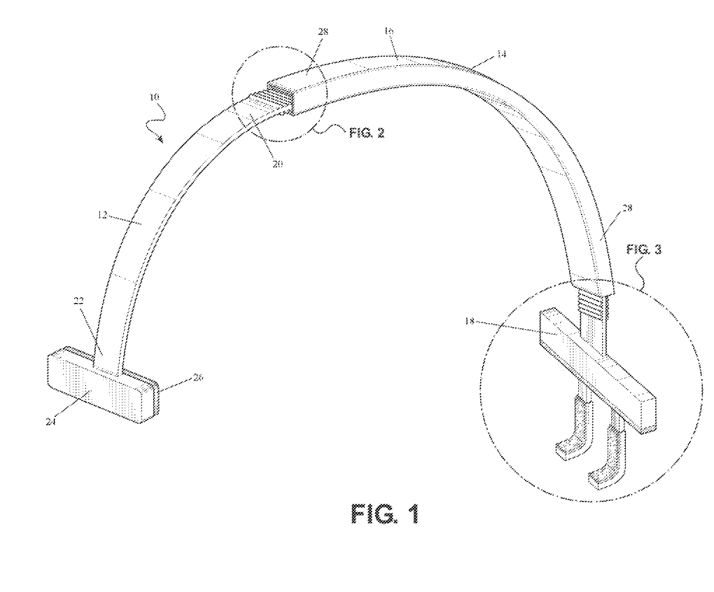

The preferred embodiment of the head mounted cell phone holder 10 is illustrated in FIGS. 1, 2, and 3. As shown in FIG. 1, the head mounted cell phone holder 10 is comprised of an arcuate male band 12 and an arcuate female band 14 interlocking to form an inverted U-shaped headband 16 with a holding member 18 attached to the female band 14. The male band 12 has a toothed end 20 and a support end 22. The support end 22 has a rectangular support block 24 attached to it wherein the support block 24 is covered with foam cushioning 26 on the inside face. The female band 14 has a hollow receiving end 28 on both ends of the female band 14.

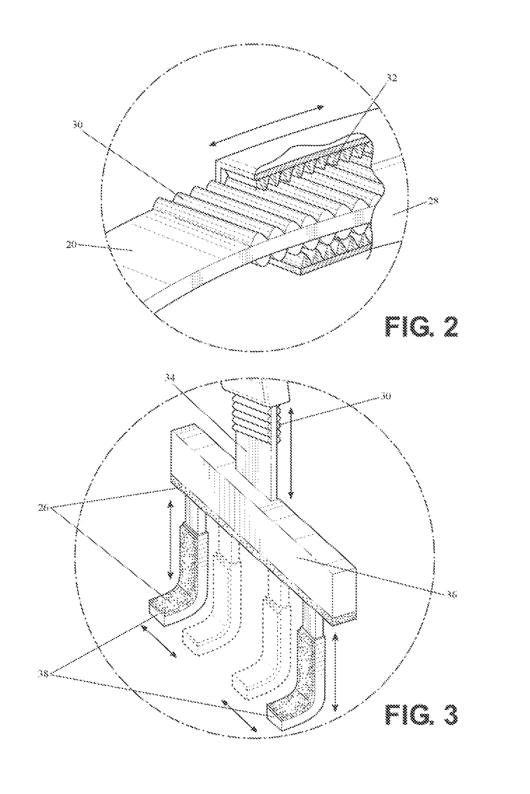

FIG. 2 shows a close up of the male band 12 interlocking with the female band 14. The toothed end 20 of the male band 12 has a plurality of rounded teeth 30 on the top and bottom surfaces of the toothed end 20. Inside the hollow receiving end 28 of the female band 14 there are a plurality of sharp teeth 32 which mesh with the rounded teeth 30 of the toothed end 20 of the male band 12. This allows the male band 12 and female band 14 to be pushed to together or pulled apart in order to adjust the size of the headband 16 easily and still retain the desired adjustment position.

FIG. 3 shows in detail the holding member 18. At the top of the holding member 18 is a male end 34 with a plurality of rounded teeth 30. The male end 34 connects to the female band 14 at one of the hollow receiving ends 28. The male end 34 is also attached to the top of the rectangular-shaped phone support 36. Two J-shaped arms 38 are attached to the bottom of the phone support 36 in such a way that the arms 38 can be independently adjusted along the length of the phone support 36. The two phone arms 38 can also be adjusted telescopically to bring the arms 38 closer to, or away from, the phone support 36. Foam cushioning 26 is attached to the inside face of the arms 38 and the bottom of the phone support 36.

The head mounted cell phone holder 10 is used by first placing a cell phone in the cell phone holder 18 with the back of the cell phone against the phone support 36 and adjusting the arms 38 to hold the cell phone from underneath in a stable fashion. The headband 16 is then placed over the user's head with the support block 24 resting on the side of the head above one ear and the cell phone holder 10, with a cell phone in it, is placed over the user's other ear. The headband 16 can be adjusted by the user to comfortably fit their head and the holding member 18 can be adjusted up or down to position the cell phone over the user's ear.

The invention has been described in only one embodiment. It should be apparent to those skilled in the art that the invention is not so limited, but susceptible to various changes and modifications without departing from the spirit of the invention.

The invention claimed is:

1. An over the head holder for portable electronic devices, comprising:
a headband having a generally inverted U-shaped form for placement on a user's head having opposite ends;
a body attached to one of the ends of the headband having an inward face shaped to receive and support the rear of a portable electronic device;
one or more arms having a proximal end and a distal end wherein the proximal end is attached to the body and the distal end is positioned to receive and support the bottom of a portable electronic device.

2. The over the head holder as recited in claim 1 wherein the one or more arms are adjustably attached at the distal end to the body.

3. The over the head holder as recited in claim 1 wherein the headband has an adjustment means to lengthen or shorten the headband.

4. The over the head holder as recited in claim 1 wherein the body is adjustably attached to the headband.

5. An over the head holder for portable electronic devices, comprising:
a headband having a generally inverted U-shaped form for placement on a user's head having opposite ends;
a body attached to one of the ends of the headband having an inward face shaped to receive and support the rear of a portable electronic device;
one or more vertically oriented, approximately J-shaped, arms having a proximal end and a curled distal end wherein the proximal end is adjustably attached to the body and the curled distal end is positioned to curl inward towards the user's head to receive and support the bottom of a portable electronic device.

6. The over the head holder as recited in claim 5 wherein the headband has an adjustment means to lengthen or shorten the headband.

7. The over the head holder as recited in claim 5 wherein the body is adjustably attached to the headband.

8. An over the head holder for portable electronic devices, comprising:
a headband having a generally inverted U-shaped form for placement on a user's head having opposite ends wherein the headband has an adjustment means to lengthen or shorten the headband;
a body adjustably attached to one of the ends of the headband having an inward face shaped to receive and support the rear of a portable electronic device;
one or more vertically oriented, approximately J-shaped, arms having a proximal end and a curled distal end wherein the proximal end is adjustably attached to the body and the curled distal end is positioned to curl inward towards the user's head and to receive and support the bottom of a portable electronic device.

9. The over the head holder as recited in claim 8 wherein the over the head holder has two vertically oriented, approximately J-shaped, arms.
